(19) United States
(12) Patent Application Publication
(10) Pub. No.: US 2025/0304760 A1
(43) Pub. Date: Oct. 2, 2025

(54) HIGH TEMPERATURE REPOLYMERIZATION RECYCLING AND PLASTICS

(71) Applicant: Andrei Gaggion Azuola, San Rafael de Heredia (CR)

(72) Inventor: Andrei Gaggion Azuola, San Rafael de Heredia (CR)

(21) Appl. No.: 18/863,990

(22) PCT Filed: Aug. 17, 2022
(86) PCT No.: PCT/IB2022/000545

§ 371 Date: Nov. 7, 2024

Related U.S. Application Data
(60) Provisional application No. 63/340,214, filed on May 10, 2022.

(51) Int. Cl. C08J 11/18; B29B 17/00; B29K 23/00; B29K 25/00; B29K 55/02; B29K 67/00; C08J 3/20; C08K 7/06; C08K 11/00

(52) U.S. Cl. CPC C08J 11/18; B29B 17/00; C08J 3/201; C08K 7/06; C08K 11/00; B29K 2023/06; B29K 2023/12; B29K 2025/06; B29K 2055/02; B29K 2067/003; C08J 2323/06; C08J 2323/12; C08J 2325/06; C08J 2367/02; C08J 2433/04

(57) ABSTRACT

Disclosed is a method for recycling a mixture of different polymers. The method includes heating an oil in a container to a process temperature greater than approximately 240 degrees Celsius. The method also includes combining two or more polymers including at least two of polystyrene, polyethylene terephthalate, acrylic butane styrene, polypropylene, or polyethylene with the heated oil in the container. The method further includes maintaining the temperature of the combination of the heated oil and the polymers at or above the process temperature. The method includes mixing the combined polymers and heated oil at least once to form a substantially homogenous liquid composition. Additionally, the method includes pouring the liquid composition into at least one mold and allowing the liquid composition to cure to form a recycled plastic material.

### TECHNICAL FIELD AND BACKGROUND OF INVENTION

This application is a Patent Cooperation Treaty Application tracing priority to U.S. Provisional Application 63/340,214 filed on May 10, 2022, the entirety of which is expressly incorporated herein by reference.

### TECHNICAL FIELD AND BACKGROUND OF INVENTION

The present disclosure generally relates to polymer recycling and, more particularly, to recycling mixtures of polymers.

Humans increasingly use plastic materials, e.g., polymers, in personal matters, business matters, and substantially every facet of day-to-day life. While plastic materials are durable, reliable, cheap to produce, etc. plastic materials are known to take hundreds and even thousands of years to decompose or breakdown. Thus, recycling has become common in most of the world in order to alleviate the resulting waste from plastic products. However, recycling can be a cost and time intensive procedure. Typical recycling processes require for the separation of different plastic types, such as polymer types. For instance, a recycling process suitable for one type of plastic is generally may not be suitable for a different type of plastic. The need to separate recycling has led to many recycling programs limiting the types of plastics they accept. Additionally, previous recycling processes are not suitable for use with plastic materials containing foreign substances, such as food residue or the like, or at least substantial quantities of the same.

As a result of current recycling limitations, consumers often dispose of plastics in the trash or improperly recycle products that they wish were recyclable (colloquially referred to as wish-cycling). At recycling plants, centers, etc. many tons of improperly sorted or contaminated plastic products are designated as waste and disposed of in another way (such as shipped to a landfill). To compound such problem, improperly recycled waste is often mixed with large quantities of otherwise acceptable recycling products in the same container, vat, load, etc., and it is common practice to dispose of the entire container of plastic for one improperly recycled waste product or the wrong type of plastic.

As such, a need exists in the art for improved recycling processes that overcome the above limitations.

### BRIEF SUMMARY OF INVENTION

Therefore, it is an object of the invention to address the above needs and/or achieve other advantages by providing recycling processes and associated systems and resulting plastic products and materials that overcome the limitations of the known art. To achieve the foregoing and other objects and advantages, in one aspect, the present subject matter is directed to a method of recycling plastic materials. The method includes heating an oil in a container to a process temperature greater than approximately 240 degrees Celsius. The method also includes combining two or more polymers including at least two of polystyrene, polyethylene terephthalate, acrylic butane styrene, polypropylene, or polyethylene with the heated oil in the container. The method further includes maintaining the temperature of the combination of the heated oil and the polymers at or above the process temperature. The method includes mixing the combined polymers and heated oil at least once to form a substantially homogenous liquid composition. Additionally, the method includes pouring the liquid composition into at least one mold and allowing the liquid composition to cure to form a recycled plastic material.

In at least one embodiment, combining the two or more polymers with the heated oil in the container may further include combining four or more polymers including polystyrene, polyethylene terephthalate, acrylic butane styrene, and at least one of polypropylene or polyethylene with the heated oil in the container. Additionally or alternatively, the four or more polymers may be included in a mixture of recycled materials including food residue, a contaminate, or both. In additional or alternative embodiments, the method may include repolymerizing each of the four or more polymers. In an additional or alternative embodiment, the method may include producing elemental carbon molecules intermixed within the combined polymers and heated oil. Additionally or alternatively, the method may include producing a plurality of fibers. Each fiber of the plurality of fibers may include elemental carbon molecules arranged in a chain. In an additional or alternative embodiment, heating the oil in the container to the process temperature may include heating the oil to a temperature sufficient to cause the oil to at least one of separate or produce carbon char. Additionally or alternatively, maintaining the temperature of the combination of the heated oil and the polymers at or above the process temperature may include depolymerizing each of the four or more polymers.

In some additional or alternative embodiments, combining the four or more polymers with the heated oil in the container may include adding at least one portion of each of the four or more polymers to the heated oil in at least four separate batches of polymer. In an additional or alternative such embodiment, mixing the combined polymers and heated oil at least once to form a substantially homogenous liquid composition may include at least one of mixing the heated oil as each batch of polymer is added to the heated oil or mixing the heated oil subsequent to adding each batch of polymer to the heated oil. In an additional or alternative embodiment, the method may include cooling the at least one mold, the liquid composition in each mold of the at least one mold, or both. Additionally or alternatively, allowing the liquid composition to cure may include polymerization by condensation of at least one polymer of the liquid composition. Additionally or alternatively, maintaining the temperature of the combination of the heated oil and the polymers at or above the process temperature may include depolymerizing each of the four or more polymers and repolymerizing the combined polymers. In some additional or alternative embodiments, the four or more polymers may include polyethylene. Additionally or alternatively, the four or more polymers may include polypropylene and polyethylene.

In some additional or alternative embodiments, the process temperature may be approximately 300 degrees Celsius or higher. In additional or alternative embodiment, the method may include heating the oil combined with at least two polymers of the four or more polymers to a second process temperature, higher than the process temperature. In some embodiments, the second process temperature may be approximately 350 degrees Celsius or higher. In additional or alternative such embodiments, the method may include heating the combined polymers and heated oil to a third process temperature, higher than the second process temperature. In some embodiments, the third process temperature may be approximately 350 degrees Celsius or higher.

In additional or alternative embodiments, the method may further include adding one or more additives to the combined polymers and heated oil. In some embodiments, the additive(s) may include at least one of hydraulic cement, urea melamine, high alumina silicate sand, or a flame retardant additive. In additional or alternative embodiments, the method may further include adding the additive(s) to the combined polymers and heated oil while heating the combined polymers and the heated oil to the third process temperature, after heating the combined polymers and heated oil to the third process temperature, or both. In additional or alternative embodiments, the method may include adding oil, removing oil, or otherwise configuring a quantity of the oil in the container such that a weight of the oil is approximately 30% to 40% of the weight of the liquid composition.

Additionally or alternatively, the method may include pouring a cement additive into the combined polymers and heated oil. In one such embodiment, the combined polymers and heated oil may not be mixed while pouring the cement additive. Additionally or alternatively, the method may include mixing the combined cement additive, the polymers, and the heated oil to form the substantially homogenous liquid composition. The cement additive may include a reactant in a chemical reaction that occurs within the combined cement additive, the polymers, and the heated oil such that the chemical reaction produces a gaseous product of the chemical reaction. Further, the mixing of the combined cement additive, the polymers, and the heated oil may be started after the production of the gaseous product of the chemical reaction has substantially stopped. In an further or alternative embodiment, the method may include adding one or more additional additives including one or more of urea melamine, high alumina silicate sand, or a flame retardant additive to the combined cement additive, the polymers, and the heated oil. The method may also include mixing the combined additional additive(s), the cement additive, the polymers, and the heated oil to form the substantially homogenous liquid composition.

In an additional or alternative aspect, the present subject matter is directed to a plastic material formed from a mixture of recycled polymers. The plastic material includes a matrix including a repolymerization of four or more polymers. The four or more polymers include polystyrene, polyethylene terephthalate, acrylic butane styrene, and polypropylene, polyethylene, or both. The plastic material also includes a plurality of carbon fibers intermixed throughout the matrix. Each fiber of the plurality of fibers include elemental carbon molecules arranged in a chain.

In at least some embodiments, the four or more polymers may include polystyrene, polyethylene terephthalate, acrylic butane styrene, and polyethylene. In an additional or alternative embodiment, the four or more polymers may further include polypropylene. In additional or alternative embodiments, the repolymerization of the four or more polymers may be formed from a mixture including approximately 15% to 25% of the total weight of the plastic material in polystyrene, approximately 15% to 20% of the total weight of the plastic material in polyethylene terephthalate, and approximately 3% to 5% of the total weight of the plastic material in acrylic butane styrene. Additionally or alternatively, the repolymerization of the four or more polymers is formed from a mixture further including approximately 15% to 25% of the total weight of the plastic material in polyethylene. In an additional or alternative embodiment, the plurality of carbon fibers may be arranged in a plurality of carbon pipes intermixed through the matrix.

In some additional or alternative embodiments, the plastic material may include one or more additives including at least one of a cement additive, urea melamine, high alumina silicate sand, or a flame retardant additive. In additional or alternative embodiments, the plastic material may be configured as at least a portion of at least one of a subfloor, a carpet, a rug, a mat, or textile. In at least one such embodiment, the plastic material may include a flame retardant additive. In a further or alternative embodiment, the plastic material may be configured as at least a portion of a construction material. In at least one such embodiment, the plastic material may further include the cement additive.

Embodiments of the inventive concepts can include one or more or any combination of the above aspects, features, and configurations.

Additional features, aspects, and advantages of the invention will be set forth in the detailed description that follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWING FIGURES

A full and enabling disclosure of the present invention, including the best mode thereof, directed to one of ordinary skill in the art, is set forth in the specification, which makes reference to companying drawings. Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. In the drawings:

FIG. 1 illustrates an embodiment of a plastic material formed from multiple polymers, in accordance with exemplary aspects of the present disclosure;

FIG. 2 illustrates an embodiment of a system for forming recycled plastic materials from a plurality of polymers, in accordance with exemplary aspects of the present disclosure;

FIG. 3 illustrates a schematic view of an embodiment of a method for producing a plastic material, in accordance with exemplary aspects of the present disclosure;

FIG. 4 illustrates a schematic view of another embodiment of the method for producing a plastic material, in accordance with exemplary aspects of the present disclosure;

FIG. 5 illustrates a schematic view of another embodiment of the method for producing a plastic material, in accordance with exemplary aspects of the present disclosure; and

FIG. 6 illustrates a schematic view of another embodiment of the method for producing a plastic material, in accordance with exemplary aspects of the present disclosure.

### Like reference numerals in the drawings may represent and refer to the same, analogous, or similar elements, features, or functions.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention. The inventive concepts are described hereinafter with reference to the accompanying drawings in which exemplary embodiments are shown. However, the inventive concepts may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Unless described or implied as exclusive alternatives, features throughout the drawings and descriptions should be taken as cumulative, such that features expressly associated with some particular embodiments can be combined with other embodiments. It is envisioned that other embodiments may perform similar functions and/or achieve similar results. Any and all such equivalent embodiments and examples are within the scope of the present invention and are intended to be covered by the appended claims.

The terms “coupled,” “fixed,” “attached to,” and the like refer to both direct coupling, fixing, or attaching, as well as indirect coupling, fixing, or attaching through one or more intermediate components or features, unless otherwise specified herein.

The inventive concepts disclosed herein are generally directed to a plastic material formed from a mixture of recycled polymers and associated systems and methods for making the same. In various embodiments, the systems and methods disclosed herein may allow for more polymers to be recycled in a single process, increase the speed of recycling mixtures of multiple polymers, and/or may reduce or eliminate the need to remove foreign substances from raw recycling materials (e.g., food residue and other non-polymers).

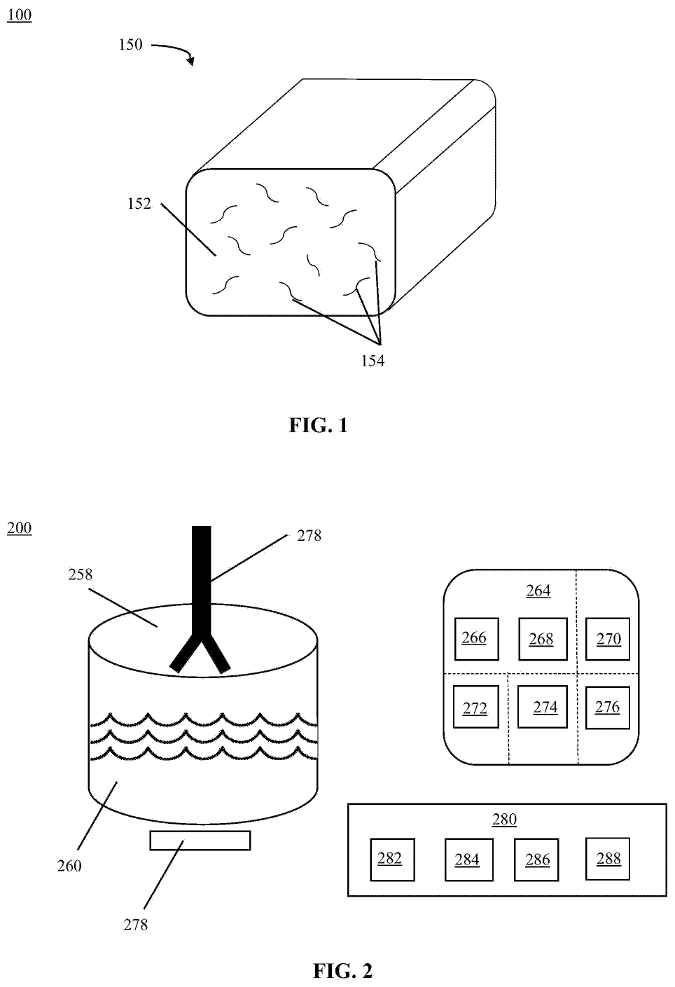

Referring now to the exemplary embodiment depicted in FIG. 1, a plastic material 150 is illustrated in accordance with aspects of the present subject matter. As shown, the plastic material 150 may include a matrix material (matrix 150) of polymers, plastics, additives, and the like. As further depicted, the plastic material 150 may include a plurality of carbon fibers 154 intermixed throughout the matrix 152. Generally and in some example embodiments, at least one carbon fiber 154, such as a portion of the carbon fibers 154, such as all of the carbon fibers 154, of the plastic material 150 may include elemental carbon molecules arranged in a chain. In several embodiments, the matrix 152 may include a repolymerization of multiple polymers. For instance and also with reference to FIG. 2, the matrix 152 may include a repolymerization of two or more polymers, such as four or more polymers. As an example and for ease of discussion, a first batch of polymer 266 of the plastic material 150 may include polystyrene. Additionally or alternatively, a second batch of polymer 268 of the plastic material 150 may include polyethylene terephthalate. In an additional or alternative embodiment, a third batch of polymer 270 of the plastic material 150 may include acrylic butane styrene. In some further or alternative embodiments, a fourth batch of polymer 272 may include polypropylene. Additionally or alternatively, the plastic material 150 may include polyethylene in a fifth batch of polymer 274. In some embodiments, the matrix 152 may include or be formed from a polymerization of at least polystyrene, polyethylene terephthalate, acrylic butane styrene, polypropylene, and polyethylene. As an example, the matrix 152 and/or plastic material 150 may include a repolymerization of a mixture of polymers including approximately 15% to 25% of the total weight of the plastic material in polystyrene, approximately 15% to 20% of the total weight of the plastic material in polyethylene terephthalate, and approximately 3% to 5% of the total weight of the plastic material in acrylic butane styrene. Additionally or alternatively, the mixture of polymers subsequently repolymerized may further include approximately 15% to 25% of the total weight of the plastic material in polyethylene.

Referring now particularly to the embodiment of FIG. 2, a system 200 for forming repolymerized and/or recycled plastic materials is illustrated in accordance with aspects of the present disclosure. In some embodiments, the system 200 is generally suitable to form the plastic material 150, the matrix material 152, and/or the carbon fibers 154 as shown in FIG. 1. The system 200 may include a container 258 (e.g., a vat, cauldron, tank, a component of a commercial mixer, and/or the like). The system 200 also includes a mixing element 278 configured stir and/or mix the contents of the container 258, such as selectively. In some embodiments, the mixing element 258 may include a ladle, spindle, spoon, drum mixer, rotor, or the like suitable to mix or stir the contents of the container 258. It should be appreciated that the mixing element 278 may be manually powered (e.g., by a user of the system) or may be powered to automatically mix the contents of the container 258 (e.g., mechanically powered, electrically powered, pneumatically powered, hydraulically powered, and the like).

Additionally, the system 200 may include a heating element 278 (e.g., an electric coal, flame, or the like), which allows for a temperature of the of contents of the container to be controlled or regulated. For example, the heating element 278 and/or system 200 may include or be associated with various sensors, probes, thermostats, or the like suitable to determine the temperature of the contents of the container 258. In some embodiments, the heating element 278 may be configured to allow for a user to adjust the same and thus the temperature of the contents of the container 258. Additionally or alternatively, temperature control of the contents of the container 258 via the heating element 278 and/or mixing the contents of the container 258 utilizing the mixing element 278 may be a semi-automatic or automatic process. The system 200 may include or be utilized in conjunction with one or more carbon-based oils (e.g., a petroleum product, by-product, or the like). With reference to the embodiments of FIG. 2, container 258 is shown after receiving oil 260.

As explained above, the system 200 may include or be utilized in conjunction with polymers 264 (such as any two or more of first polymer 266 through fifth polymer 274). In some embodiments, the polymers 264 may be generally or substantially sorted based on a type, class, or group of similar polymers. For instance, the polymers 264 may be organized in batches (e.g., a first batch 266, a second batch 268, and so on). In some instances, each batch of the polymers 264 includes substantially one type of polymer, e.g., the first batch 266 may include only or substantially only polystyrene. However, in other embodiments, one or more batches may include more than one of the polymers 264. For example, two types of polymers may be in the first batch 266 (e.g., polystyrene and polyethylene terephthalate). Similarly or alternatively, the second batch 268 may include two or more types of polymers (e.g., acrylic butane styrene and polypropylene). Additionally or alternatively, each batch of the polymers 264 may include a mixture of three or more, such as four or more polymers, as disclosed herein. For example, polymers 264 may be mixed and/or not separated into different types of polymers. In such instances, there may only be one batch (e.g., first batch 266) up to as many batches as desired or required. As depicted in FIG. 2, the polymers 264 may include one or more additional or alternative polymers (e.g., a sixth batch 276) suitable to form plastic material 150 and/or suitable for use with any of the methods described herein. In one embodiment, the sixth batch 276 may include one or more polyamides. Further, one type of polymer may be split into multiple different batches.

It may be desirable to add one or more additives 280 while producing the plastic material 150 in order to alter one or more properties thereof. Thus, various example embodiments of the plastic material 150 may include one or more additives 280, including but not limited to a cement additive (e.g., a first additive 282), urea melamine (e.g., a second additive 284), high alumina silicate sand (e.g., a third additive 286), or a flame retardant additive (e.g., a fourth additive 288), as depicted in FIG. 2. In some embodiments, the system 200 may include or be utilized in conjunction with additional or alternative additives suitable for the purpose of the resulting plastic material 150 and/or resulting in desirable properties in any future product.

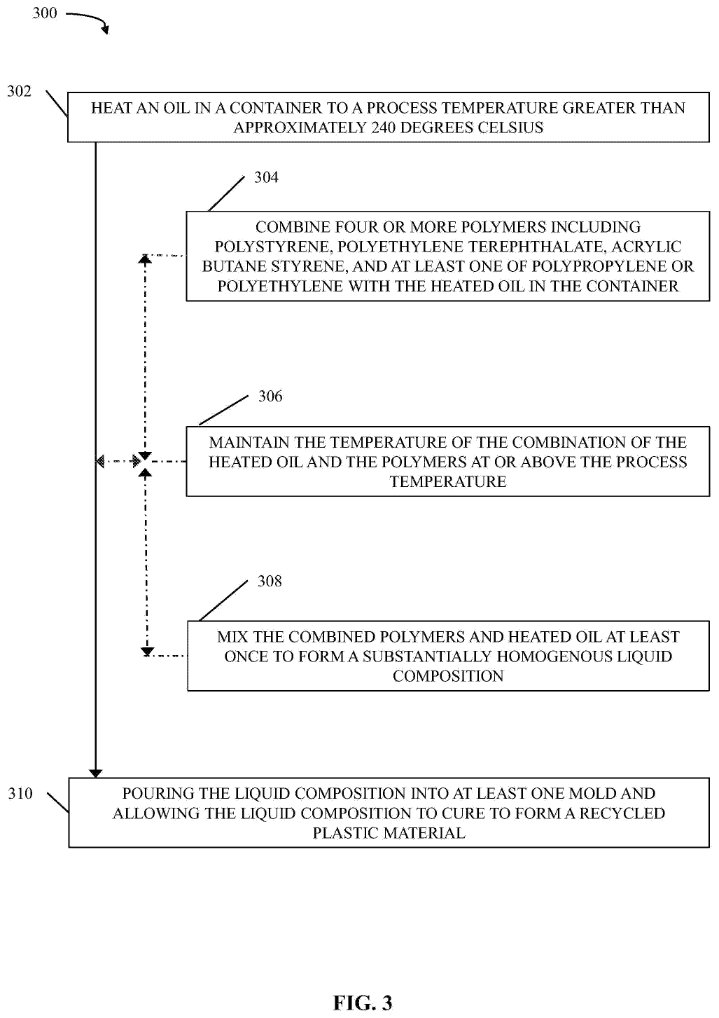

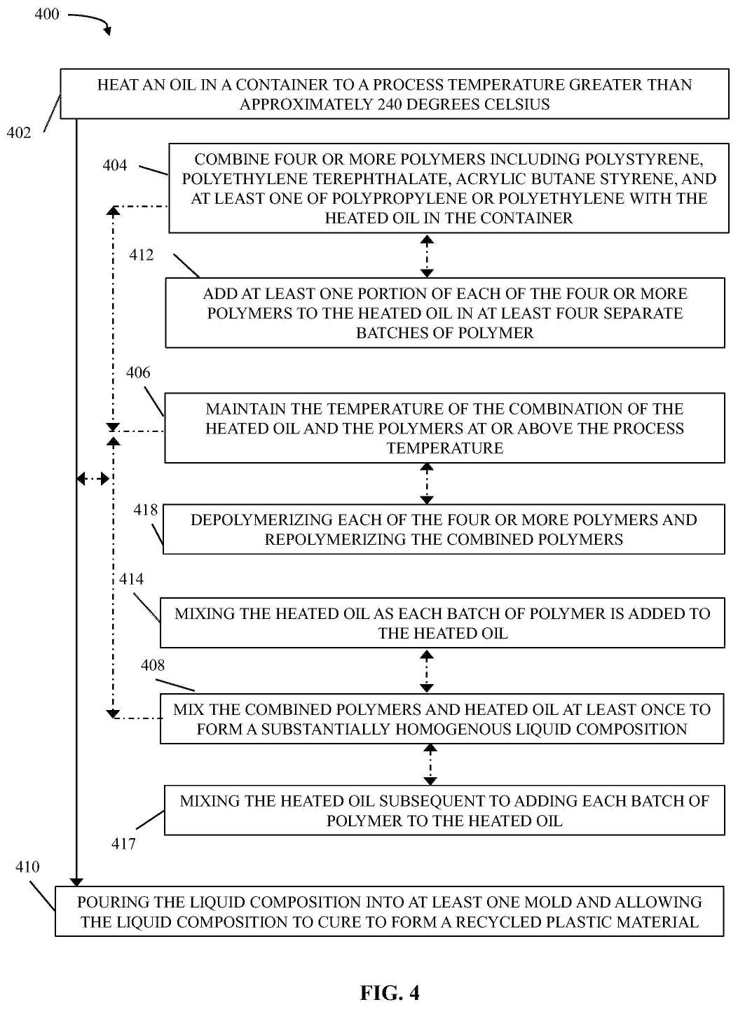

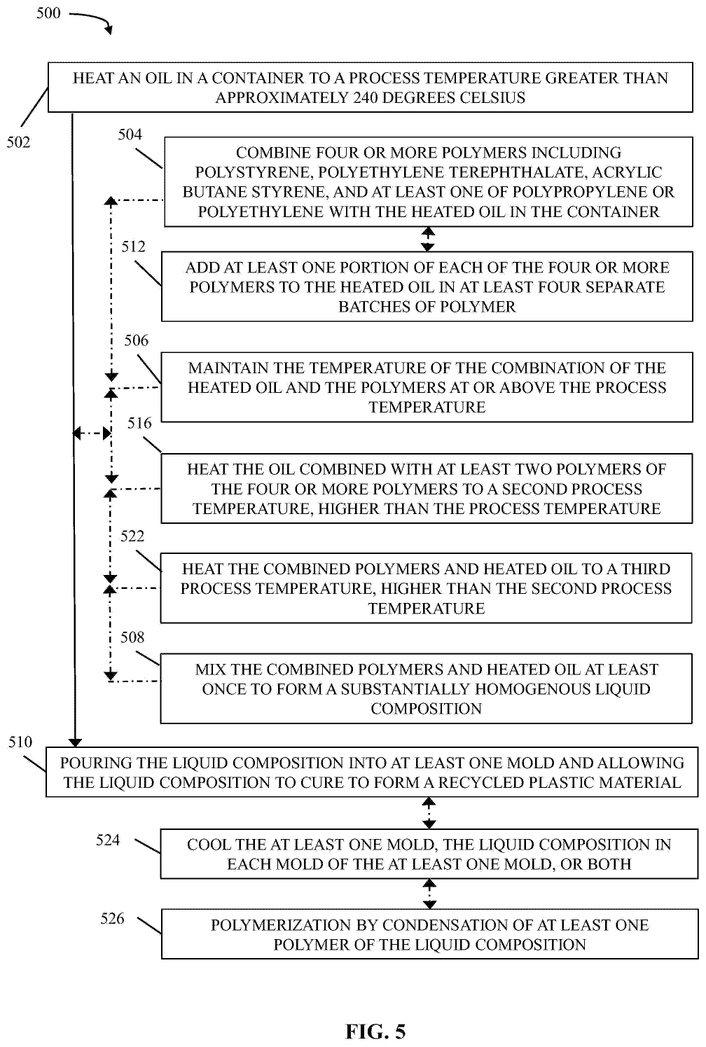

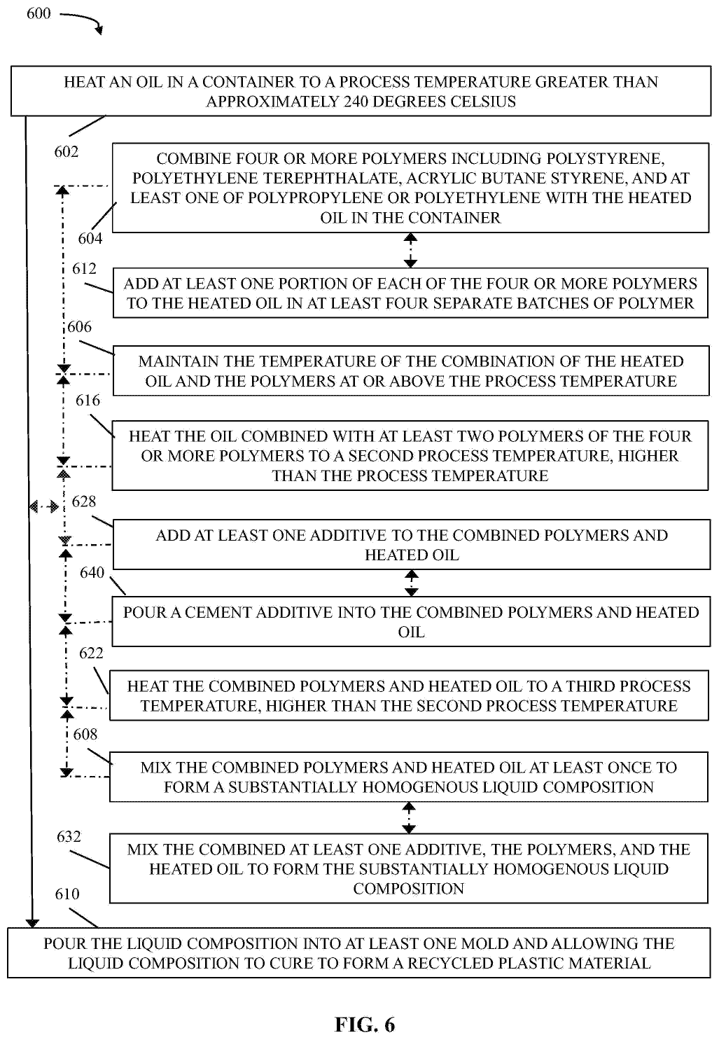

Referring now to FIGS. 3-6, exemplary embodiments of various methods of recycling plastic materials are illustrated in accordance with aspects of the present subject matter, (e.g., method 300, method 400, method 500, method 600, or combinations of the elements thereof). The method may be utilized with the system 200, similar, and/or suitably configured system to form a plastic material including a repolymerization of four or more polymers and carbon fibers resulting from carbonization of a carbon-based oil (e.g., during the repolymerization process). In at least one embodiment, the four or more polymers may be in one or more mixtures of recycled materials including food residue, a contaminate, or both (e.g., a non-polymer substance).

The method may include (method elements 302, 402, 502, 602) heating an oil in a container to a process temperature greater than approximately 240 degrees Celsius. For example, heating element 278 may be used to raise the temperature of the oil 260 to at least the process temperature. The oil 260 may be heated to the process temperature before adding any polymers 264 to the container 258. However, in other embodiments, one or more batches (e.g., the first batch 266, the second batch 268, etc.) may be added to the oil 260 before heating the oil 260 and/or before reaching the process temperature. In additional or alternative embodiments, the method may include adding oil, removing oil, or otherwise configuring a quantity of the oil in the container such that a weight of the oil is approximately 30% to 40% of the weight of the combined polymers 264, oil 260, and/or additives 280.

In various embodiments, heating the oil 260 in the container 258 to the process temperature may include heating the oil 260 to a temperature sufficient to cause carbon of the oil to at least one of separate or produce carbon char. Generally, the carbon fibers 154 of the plastic material 150 may be formed from carbon separated from the oil 260, such as elemental carbon. In some additional or alternative embodiments, the process temperature may be approximately 300 degrees Celsius or higher. Thus and in some embodiments, the method may include producing elemental carbon molecules intermixed within the combined polymers 264 and heated oil 260. For example, the method may include producing or result in the formation of the carbon fibers 154 intermixed throughout the matrix material 152, as described with reference to FIG. 1. Some of the carbon fibers 154, such as all of the carbon fibers 154, may include elemental carbon molecules arranged in a chain.

Additionally or alternatively, the method may include combing two or more polymers including at least two of polystyrene, polyethylene terephthalate, acrylic butane styrene, polypropylene, or polyethylene with the heated oil in the container. In several embodiments (see, e.g., method elements 304, 404, 504, 604), the method may include combining four or more polymers including polystyrene, polyethylene terephthalate, acrylic butane styrene, and at least one of polypropylene or polyethylene with the heated oil in the container. In some embodiments, the polymers 264 may include one or more polyamides or other suitable polymers. For example, any of the polymers 264 and/or one or more batches of the same (e.g., the first batch 268, the second batch 270, etc.) may be added to the container 258 with the oil 260, such as sequentially. In other embodiments, one large batch 266 of polymers 268 may be added to the container 258 (e.g., unsorted, polymer recycling materials). In some additional or alternative embodiments, the four or more polymers 264 may include polyethylene. Additionally or alternatively, the four or more polymers 264 may include polypropylene and polyethylene. In one embodiments the polymers 264 may include five or more polymers and/or include polypropylene and polyethylene.

The method may include (e.g., method elements 306, 406, 506, 606) maintaining the temperature of the combination of the heated oil and the polymers at or above the process temperature. In some embodiments, maintaining the temperature of the combination of the heated oil 260 and the polymers 264 at or above the process temperature may include depolymerizing each of the polymers 264 (e.g., method element 418). Thus, the process temperature may be greater than the temperature of depolymerization of at least one of the polymers 264, such as all of the polymers 264. Additionally or alternatively (e.g., method element 418), the method may include repolymerizing each of the polymers 264.

As further illustrated in method elements 308, 408, and 508, the method may include mixing the combined polymers and heated oil at least once to form a substantially homogenous liquid composition. It should be appreciated that mixing the contents of the container 258 may be done prior to, during, and/or after adding the polymers 264 or portions thereof. For example (e.g., method clement 412, 512, 612), the method may include adding at least a portion of each of the four or more polymers to the heated oil in at least four separate batches of polymer. For example, the polymers may be added in sequential batches (e.g., the first batch 266 up to the fifth batch 274 and/or any additional or alternative batches 276. In such embodiments, the method may include mixing the heated oil as each batch of polymer is added to the heated oil or mixing the heated oil subsequent to adding each batch of polymer to the heated oil (see method elements 414, 417). Thus and in various embodiments of the method, maintaining the temperature of the combination of the oil 260 and the polymers 264 at or above the process temperature (e.g., method elements 306, 406, 506, and 606) may include depolymerizing each of polymers 264 and repolymerizing the combined polymers 264 (e.g., method element 418).

In some embodiments, the method may include heating the oil combined with at least two polymers of the four or more polymers to a second process temperature, higher than the process temperature (e.g., method elements 516, 616). In some embodiments, the second process temperature may be approximately 350 degrees Celsius or higher. In additional or alternative embodiments and as shown in method element 522 and method clement 622, the method may include heating the combined polymers and heated oil to a third process temperature, higher than the second process temperature. In some embodiments, the third process temperature may be approximately 350 degrees Celsius or higher. Thus, polymers 264 that depolymerize at different and/or distinct temperatures may be added and/or melted sequentially utilizing a tiered heating strategy. By sequentially melting the polymers 264 in an order of increasing temperature of depolymerization, the depolymerization of each polymer 264 and/or the depolymerization of the combination of polymers 264 may be accelerated. Additionally or alternatively, such a heating strategy may be utilized individually in combination with associated batches (e.g., a first batch 266 of low-temp polymerization polymers and a second batch 268 of high-temp polymerization polymers) to make mixing the contents of the container 258 easier, faster, or require less power.

The method may generally include (method elements 310, 410, 510, 610) pouring the liquid composition into at least one mold and allowing the liquid composition to cure to form a recycled plastic material. For example and after the depolymerized polymers 264 are mixed to form the substantially homogeneous liquid composition (e.g., any of method elements 308, 408, 418, 417, 508, or 608), the resulting composition may be poured into a mold in any shape desired or required to form a recycled plastic product (e.g., a product including a plastic material 150). In some embodiments, e.g., method clement 524, the method may include cooling the at least one mold, the liquid composition in each mold of the at least one mold, or both. Additionally or alternatively, allowing the liquid composition to cure may include polymerization by condensation of at least one polymer of the liquid composition (e.g., method element 526).

In various further or alternative embodiments, the method may include adding one or more additives to the combined polymers and heated oil, see method element 628. For example, any one or more of the additives 280 may be added to the contents of the container 258, the oil 260, the mixture of the oil 260 and polymers 264, and/or the resulting liquid composition. In some embodiments, the method may include adding a cement additive, hydraulic cement, or the like (e.g., the first additive 282); urea melamine (e.g., the second additive 284); high alumina silicate sand (e.g., the third additive 286); a flame retardant additive (e.g., the fourth additive 288); and/or any additional or alternative additives desired or required. For example, the method may further include adding the additive(s) 280 to the combined polymers 264 and heated oil 260 while heating the combined polymers 264 and the heated oil 260 to the third process temperature, after heating the combined polymers 264 and heated oil 260 to the third process temperature, or both.

As shown in method clement 632, method may include mixing the combined additive(s), the polymers, and the heated oil to form the substantially homogenous liquid composition. In various embodiments, method may also include mixing a combined cement additive, the polymers 264, the heated oil 260 and/or an additional additive(s) to form the substantially homogenous liquid composition. In some embodiments, the combined polymers 264 and heated oil 260 may not be mixed while pouring the cement additive. As shown in method element 640 and for example, the method may include pouring a cement additive into the combined polymers and heated oil and/or in the resulting liquid composition. Generally, the cement additive may include a reactant in a chemical reaction that occurs within the combined cement additive, the polymers 264, and the heated oil 260. Such chemical reaction may generate a gaseous product of the chemical reaction. In a further or alternative embodiment, the method may include adding one or more additional additives 280 to the combined cement additive, the polymers 264, and the heated oil 260, such as urea melamine, high alumina silicate sand, and/or a flame retardant. In some embodiments, mixing of the combined additives 280 (including the cement additive), the polymers 264, and the heated oil 260 may be started after production of the gaseous product of the chemical reaction has fully or substantially stopped.

Thus, various embodiments of the methods described herein, such as method 300, method 400, method 500, method 600, combinations of the elements thereof, and/or other similar or suitable methods may produce the plastic material 150 or a similar plastic material. In some embodiments, the plastic material 150 may be configured for use as at least a portion of a subfloor, a carpet, a rug, a mat, a textile, or the like. In at least one such embodiment, the plastic material 150 may include a flame retardant additive in order to reduce the risk of fire for such products. In a further or alternative embodiment, the plastic material 150 may be configured for use as at least a portion of a construction material. In at least one such embodiment, the plastic material 150 may further include the cement additive in order to strengthen the construction material. In some instance, the addition of the cement additive in the plastic material and/or an associated method to make the same, as described herein, may cause the carbon fibers 154 to be arranged in a plurality of carbon pipes intermixed through the matrix 154. Furthermore, a plastic material 150 including the cement additive and/or carbon fibers 154 arranged in carbon pipes may substantially increase the resulting strength and/or utility of the same.

The foregoing has described various embodiments of a recycling process and associated systems and plastic materials. While specific embodiments of the present invention have been described, it will be apparent to those skilled in the art that various modifications thereto can be made without departing from the spirit and scope of the invention. Accordingly, the foregoing description of the invention and the best mode for practicing the invention are provided for the purpose of illustration only and not for the purpose of limitation. It is envisioned that other embodiments may perform similar functions and/or achieve similar results. Any and all such equivalent embodiments and examples are intended to be within the scope of the claims if they include structural elements that do not differ from the literal language of the claims, or if they include equivalent structural elements with insubstantial differences from the literal languages of the claims.

1. A method of recycling plastic materials, the method comprising:
heating an oil in a container to a process temperature greater than approximately 240 degrees Celsius;
combining two or more polymers including at least two of polystyrene, polyethylene terephthalate, acrylic butane styrene, polypropylene, or polyethylene with the heated oil in the container;
maintaining the temperature of the combination of the heated oil and the polymers at or above the process temperature;
mixing the combined polymers and heated oil at least once to form a substantially homogenous liquid composition; and
pouring the liquid composition into at least one mold and allowing the liquid composition to cure to form a recycled plastic material.

2. The method of claim 1, wherein combining two or more polymers with the heated oil in the container further comprises:
combining four or more polymers including polystyrene, polyethylene terephthalate, acrylic butane styrene, and at least one of polypropylene or polyethylene with the heated oil in the container.

3. The method of claim 2, further comprising:
repolymerizing each of the four or more polymers.

4. The method of claim 2, wherein the four or more polymers are included in a mixture of recycled materials including at least one of food residue or a contaminate.

5. The method of claim 2, further comprising:
heating the oil combined with at least two polymers of the four or more polymers to a second process temperature, higher than the process temperature.

6. The method of claim 5, wherein the second process temperature is approximately 350 degrees Celsius or higher.

7. The method of claim 5 further comprising:
heating the combined polymers and heated oil to a third process temperature, higher than the second process temperature.

8. The method of claim 7, wherein the third process temperature is approximately 350 degrees Celsius or higher.

9. The method of claim 7 further comprising:
adding at least one additive to the combined polymers and heated oil while heating the combined polymers and the heated oil to the third process temperature, after heating the combined polymers and heated oil to the third process temperature, or both.

10. The method of claim 2, wherein the four or more polymers include polyethylene.

11. The method of claim 2, wherein the four or more polymers include polypropylene and polyethylene.

12. The method of claim 2, wherein maintaining the temperature of the combination of the heated oil and the polymers at or above the process temperature comprises depolymerizing each of the four or more polymers and repolymerizing the combined polymers.

13. The method of claim 2, wherein combining the four or more polymers with the heated oil in the container comprises adding at least one portion of each of the four or more polymers to the heated oil in at least four separate batches of polymer.

14. The method of claim 13, wherein mixing the combined polymers and heated oil at least once to form a substantially homogenous liquid composition comprises at least one of mixing the heated oil as each batch of polymer is added to the heated oil or mixing the heated oil subsequent to adding each batch of polymer to the heated oil.

15. The method of claim 1, further comprising:
producing elemental carbon molecules intermixed within the combined polymers and heated oil.

16. The method of claim 1, further comprising:
producing a plurality of fibers, each fiber including elemental carbon molecules arranged in a chain.

17. The method of claim 1, wherein heating the oil in the container to the process temperature comprises heating the oil to a temperature sufficient to cause the oil to at least one of separate or produce carbon char.

18. The method of claim 1, further comprising:
cooling the at least one mold, the liquid composition in each mold of the at least one mold, or both.

19. The method of claim 1, wherein allowing the liquid composition to cure includes polymerization by condensation of at least one polymer of the liquid composition.

20. The method of claim 1, wherein the process temperature is approximately 300 degrees Celsius or higher.

21. The method of claim 1, further comprising:
adding at least one additive to the combined polymers and heated oil.

22. The method of claim 21, wherein the at least one additive comprises at least one of hydraulic cement, urea melamine, high alumina silicate sand, or a flame retardant additive.

23. The method of claim 1, further comprising:
adding oil, removing oil, or otherwise configuring a quantity of the oil in the container such that a weight of the oil is approximately 30% to 40% of the weight of the liquid composition.

24. The method of claim 1, further comprising:
pouring a cement additive into the combined polymers and heated oil.

25. The method of claim 24, wherein the combined polymers and heated oil are not mixed while pouring the cement additive.

26. The method of claim 25, further comprising:
mixing the combined cement additive, the polymers, and the heated oil to form the substantially homogenous liquid composition,
wherein the cement additive comprises a reactant in a chemical reaction that occurs within the combined cement additive, the polymers, and the heated oil, the chemical reaction producing a gaseous product of the chemical reaction, and
wherein the mixing of the combined cement additive, the polymers, and the heated oil is started after the production of the gaseous product of the chemical reaction has substantially stopped.

27. The method of claim 26, further comprising:
adding at least one additional additive including at least one of urea melamine, high alumina silicate sand, or a flame retardant additive to the combined cement additive, the polymers, and the heated oil; and
mixing the combined at least one additional additive, the cement additive, the polymers, and the heated oil to form the substantially homogenous liquid composition.

28. A plastic material formed from a mixture of recycled polymers, the plastic material comprising:
a matrix, the matrix including a repolymerization of two or more polymers including two or more of polystyrene, polyethylene terephthalate, acrylic butane styrene, polypropylene and polyethylene; and
a plurality of carbon fibers intermixed throughout the matrix, each fiber of the plurality of fibers including elemental carbon molecules arranged in a chain.

29. The plastic material of claim 28, wherein the matrix includes a repolymerization of four or more polymers, the four or more polymers comprising polystyrene, polyethylene terephthalate, acrylic butane styrene, and at least one of polypropylene or polyethylene.

30. The plastic material of claim 28, wherein the four or more polymers comprise polystyrene, polyethylene terephthalate, acrylic butane styrene, and polyethylene.

31. The plastic material of claim 29, wherein the four or more polymers further comprise polypropylene.

32. The plastic material of claim 29, wherein the repolymerization of the four or more polymers is formed from a mixture including approximately 15% to 25% of the total weight of the plastic material in polystyrene, approximately 15% to 20% of the total weight of the plastic material in polyethylene terephthalate, and approximately 3% to 5% of the total weight of the plastic material in acrylic butane styrene.

33. The plastic material of claim 32, wherein the repolymerization of the four or more polymers is formed from a mixture further including approximately 15% to 25% of the total weight of the plastic material in polyethylene.

34. The plastic material of claim 28, further comprising:
at least one additive including at least one of a cement additive, urea melamine, high alumina silicate sand, or a flame retardant additive.

35. The plastic material of claim 28, wherein the plurality of carbon fibers is arranged in a plurality of carbon pipes intermixed through the matrix.

36. The plastic material of claim 28, further comprising:
a flame retardant additive, wherein the plastic material is configured as at least a portion of at least one of a subfloor, a carpet, a rug, a mat, or textile.

37. The plastic material of claim 28, further comprising:
a cement additive, wherein the plastic material is configured as at least a portion of a construction material.
